(19) United States
(12) Patent Application Publication
(10) Pub. No.: US 2012/0004933 A1
(43) Pub. Date: Jan. 5, 2012

(54) System And Method For The Collection And Monitoring Of Vehicle Data

(75) Inventors: Mark J. Foladare, East Brunswick, NJ (US); James A. Croley, San Ramon, CA (US); David Ohrn, Nazereth, PA (US); Carl L. Nerup, Hawthorn Wood, IL (US); Waliur Rahman, Cedar Park, TX (US); Satish Purushothaman, Wheeling, IL (US)

(73) Assignee: AT&T MOBILITY II LLC, Atlanta, GA (US)

(21) Appl. No.: 12/702,830

(22) Filed: Feb. 9, 2010

(51) Int. Cl. G06Q 40/00; G06F 17/00

(52) U.S. Cl. 705/4; 701/1

(57) ABSTRACT

A method for brokering variable rate insurance premiums from an insurance carrier includes collecting driving information relating to a vehicle, generating a report based on the driving information, providing the driving report to the insurance carrier, receiving a revised premium based on the driving report and transmitting the revised premium to a customer.

### TECHNICAL FIELD

The technical field generally relates to telematics using wireless communications and more specifically is directed to telematics embedded in vehicles to provide value added services to subscribers and insurers.

### BACKGROUND

With ubiquitous cellular telephone coverage now the norm, and with the development of location tracking to offer location-based services, there are no telematics services which allow a person traveling in a vehicle to automatically collect location, driving information, and automobile diagnostic information and use that information to obtain more cost effective automobile insurance or to enable automobile insurance companies to better evaluate and manage the risk profiles of its customers. One prior art system is General Motors' OnStar system, which, according to its website, is an in-vehicle safety and security system which is intended to protect the drivers of a vehicle on the road. It's system offers 24-hour access to advisors for navigational purposes, a connection to emergency assistance, and access to hands-free calling using the OnStar system. OnStar also collects on-board diagnostic information and provides monthly emails to its subscribers, specifically tire pressure information, oil life indication, and mileage tracking for preventive maintenance reminders. OnStar also tracks mileage and through association with GMAC Insurance, offers discounts to drivers based on the amount of miles driven in the vehicle. Notwithstanding OnStar's suite of features, it does nothing to ensure that consumers and insurers are getting the best deal or that drivers are getting the necessary feedback to gain driving efficiencies.

### SUMMARY

The present invention is directed to a telematics device for collecting driving information from a vehicle wherein the telematics device includes a driver authentication module to identify a current driver of the vehicle; an interface to a GPS system for receiving location information; a vehicle interface for collecting vehicle status data relating to one of the vehicle's driving parameters and maintenance parameters; and an interface to a wireless network configured to transmit the identify of the driver, the vehicle's location and the vehicle status data and further configured to receive data from an external source, the received data based on one of the identity of the current driver, the vehicle's location, and the vehicle status data. In one embodiment of the invention, the telematics device of includes a feedback module configured to provide driving feedback to a driver. The telematics device according to one embodiment may be configured to receive data that includes a rate quote or a variable rate quote from an insurer.

In accordance with another embodiment of the invention, the telematics device may be configured to run in a client mode whereby data is communicated to and from the telematics device through a browser interface. The browser interface is configured to receive applications, requests for data, or for receiving data, and to send data wirelessly through the network to a server within the network or connected to the network.

The invention includes a method for brokering variable rate insurance premiums from an insurance carrier to a driver including the steps of collecting driving information relating to a vehicle, generating a report based on the driving information, providing the driving report to the insurance carrier; receiving a revised premium based on the driving report; and transmitting the revised premium to a customer. In a preferred embodiment, the collecting step is performed by a telematics device installed on a vehicle or by a specially configured mobile device. The collecting step includes receiving driving information using a wireless network and wherein the driving information includes driver identification, vehicle speed and vehicle location.

From an insurer's perspective and in accordance with another embodiment of the invention, the method of the invention includes providing variable rate insurance premiums from an insurance carrier by receiving driving information collected from within a vehicle that transmitted wirelessly from the vehicle, analyzing the driving information based on a set of parameters; revising an insurance premium based on the analyzing step; and sending notice of the revised premium electronically. The method may further include providing a telematics device to be installed within the vehicle for collecting the driving information and wherein the driving information includes driver identification, vehicle speed and vehicle location. The method may include collecting driving information for a defined period of time prior to the receiving step. In alternative embodiments of the invention, the driving information is collected and sent in near real time and the driving information is aggregated over a defined time period prior to the analyzing step.

In accordance with another embodiment of the invention, there is a system for providing variable rate insurance for a vehicle including a telematics unit within a vehicle configured to collect data from sensors located within the vehicle and wherein the sensors provide information relating to the vehicle's performance or mainentance, a wireless telecommunications interface connected to the telematics unit; a network in communication with the wireless telecommunications interface; and at least one terminal connected to the network, wherein the terminal is configured to receive the information; analyze the information, and adjust insurance premiums based on the analysis of the information.

### BRIEF DESCRIPTION OF THE DRAWINGS

The following description is better understood when read in conjunction with the appended drawings.

FIG. 1 is an exemplary system that is configured for capturing and sharing telematics data in accordance with the present invention.

FIG. 2 is a block diagram showing the components of an ecosystem that forms an exemplary embodiment of the present invention.

FIG. 3 is a block diagram showing in more detail the components of an ecosystem forming an exemplary embodiment of the present invention.

FIG. 4 is a flow chart illustrating the method of collection and distribution of data according to one embodiment of the present invention.

### DESCRIPTION OF ILLUSTRATIVE EMBODIMENTS

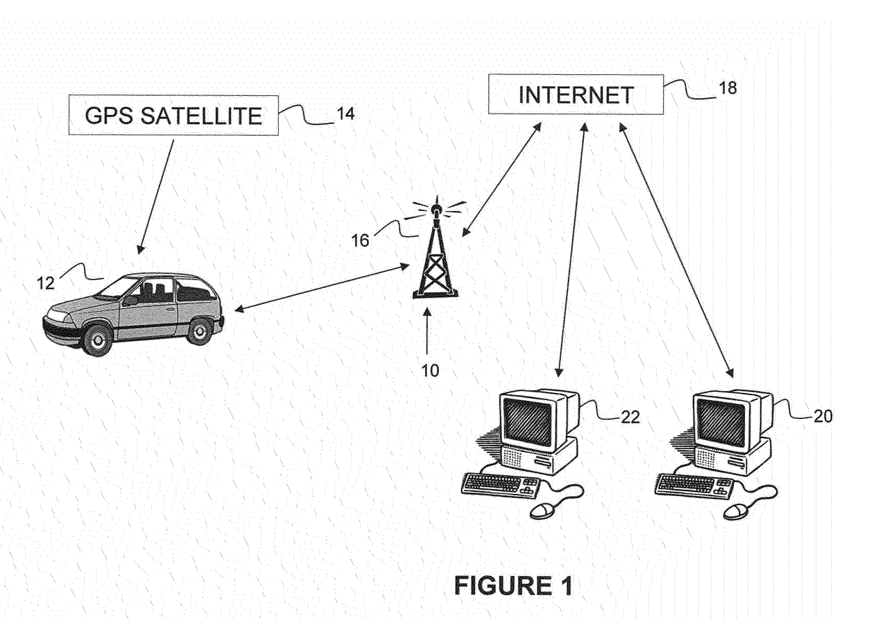

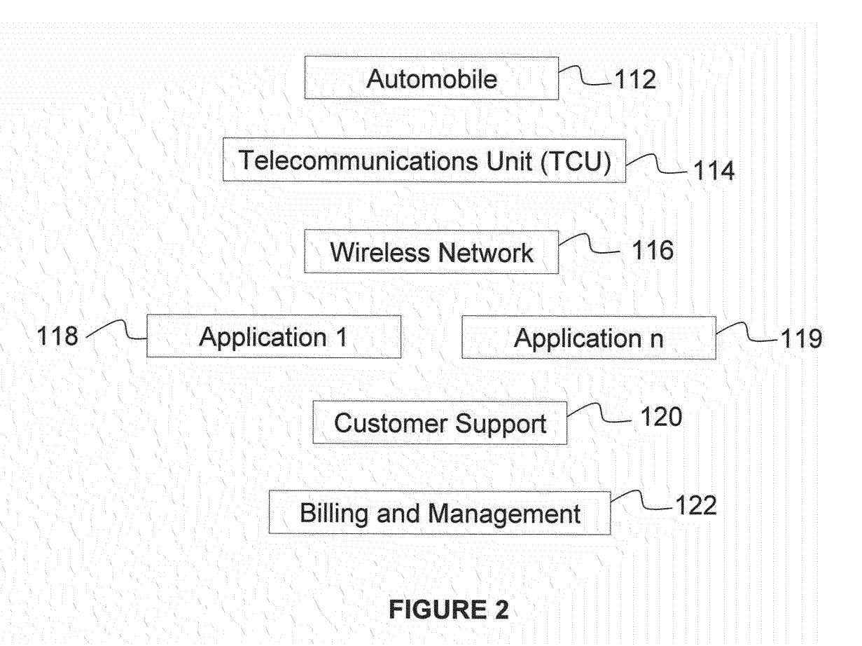

With reference to FIG. 1, there is shown the system 10 which may be constructed in an exemplary embodiment of the present invention. There is a vehicle 12 with a telecommunications unit device (shown as 114 in FIG. 2) within the vehicle 12. The vehicle receives location information from global positioning satellite (GPS) system 14. It should be understood by those skilled in the art, however, that other techniques for determining the location of the vehicle may be used, including but not limited to time-delay of arrival, assisted GPS, triangulation, and any other method now known or to be developed in the future. The telecommunications unit 114 communications in a bi-directional manner over the wireless network 16 which is in two-way communication with the network 18, which in a preferred embodiment, is the Internet. The wireless network 18 may be any type of cellular network, including but not limited to GSM, CDMA, WCDMA, 3GPP, Edge, 4G, or any other type of cellular network, and may also be any other type of wireless network, including WI-FI, WI-max, WLAN or any other type of wireless network capable of transmitting data. Attached to the network 18 are computer peripheral devices such as workstations 20, 22, it being understood by those skilled in the art that such peripheral devices may also include netbook computers, PDA's, internet-enabled mobile telephones, and any other peripheral device capable or sending or receiving data to and from the Internet.

A high level embodiment of the ecosystem of the present invention is illustrated in FIG. 2. The ecosystem may include the automobile 112 that is fitted with a telecommunications unit 114. The telecommunications unit 114 may be a port device that is plug compatible with the automobile's On-Board Diagnostic (OMB-II) port that is available on all cars from 1996 and newer. Typically, the OMB-II port is located on the driver's side of the passenger compartment near the center console. The port device preferable is universal in size such that one size fits all vehicles and is sized so as to be positioned covertly under the dash. Alternatively, the telecommunications unit 114 may be embedded in the vehicle at manufacture. A further alternative may be for a telecommunications unit 114 to be installed in the vehicle and tethered to a mobile unit such as a PDA or a mobile phone for connectivity.

Continuing with the ecosystem diagram of FIG. 2, there is shown a wireless network 116 which is of similar functionality as wireless network 16, including the various options of that network's protocol. Applications 118 and 119 are accessible to both the telecommunications unit 114 and the wireless network 116. Customer support 120 and billing and management functions 122 round out the ecosystem.

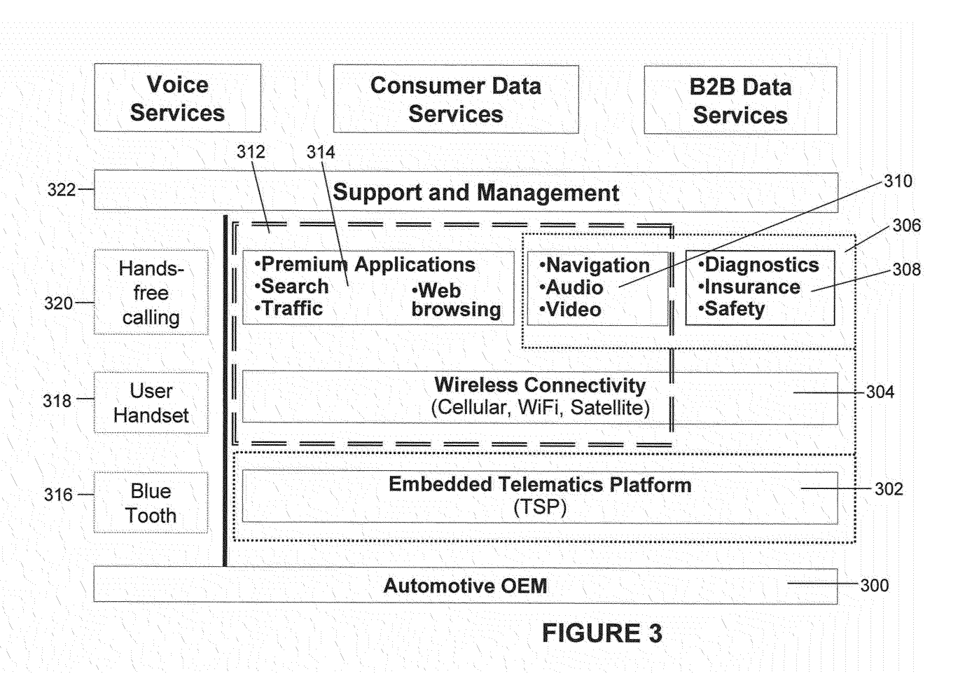

A more granular illustration of one embodiment of the ecosystem is shown in FIG. 3. In FIG. 3, the ecosystem is categorized in terms of voice services, consumer data services, and business-to-business data services. The support and management functionality is shown in block 322 and cuts across all three service descriptions. Applications are shown in block 306, and include searching, web browsing, traffic and other premium applications at block 314. Navigation, audio and video applications are shown at block 310 each of which forms part of the consumer data services applications. Diagnostics, insurance and safety applications are shown at block 308, each of which forms part of the business-to-business applications. Each of the applications in block 306 have access to the wireless connectivity shown in block 304 which interfaces to wireless network 18. The embedded telematics platform at block 302 incorporates the telecommunications unit 114 and any other peripheral devices forming the telematics platform and interfaces with the wireless connectivity 304. The telematics platform 302 collects vehicle performance and maintenance data directly from automotive original equipment manufacture devices 300 embedded in the vehicle, for example, speed sensors, oxygen sensors, tire pressure sensors, and fault code readings, to name a few. External antennas (not shown) or omni-antennas (not shown) encompassing the antenna functionality of the radio, GPS, cellular, WiFi, Bluetooth and the like may be included. The telematics platform 302 interfaces with the original equipment manufacturer of the vehicle, shown as block 300. The embedded telematics platform 302 may include blue tooth functionality, a user handset, and hands-free calling functionality, shown as blocks 316, 318, and 320, and preferably is powered by the vehicle power system with a battery backup. Memory is provided for storing and caching the collected data.

The telematics platform 302 preferably authenticates the driver of the vehicle. For example, the driver authentication may be performed using bio-metrics, i.e, fingerprint or other scans, user driving patterns, authentication using a key fob or chip, or parental controls. Once authenticated, the telematics platform 302 may retrieve a user profile, which may, for example, identify the driver (i) by name or other code, (ii) as a parent or child or authorized user, (iii) as a mechanic or service center or (iv) as an unauthorized users. The telematics platform 302 may further include a driver feedback mechanism which provides feedback to the driver based on the real-time or historical driving behavior of the driver. The feedback mechanism may, for example, include a light display such as red/yellow/green wherein the light color displayed corresponds to the target criteria based on actual performance and wherein red is unacceptable deviation, yellow is acceptable deviation but cautions the driver to improve, and green indicates acceptable driving behavior. The feedback mechanism may also include a heads-up display whereby the feedback is projected onto the drivers windshield or dash, a mobile phone message, an audio alert, or any combination of the foregoing.

In accordance with another embodiment of the invention, the telematics platform 302 may be configured to communicate through a browser loaded onto the telematics platform. Thus, operating in a client mode whereby data is communicated to and from the telematics device through a browser interface, the telematics platform is able to utilize data and applications that are resident on remote servers or in a cloud-computing configuration. The browser interface is configured to receive applications, requests for data, or for receiving data, and to send data wirelessly through the network to a remote server or remote servers within the network or connected to the network.

The ecosystem may be used to provide a variety of functions and services to users. For example, the ecosystem may be used to provide a variable rate insurance plan based on real-time driving behavior which is geared around objective, fair, and equitable insurance valuation criteria. The telematics platform 302 may collect data such as the driver identification, speed, tire pressure, gas volumes, odometer mileage, location, electronic systems information, breaking, acceleration, sensors, camera outputs, including video and still pictures, audio data including voice recordings, breath analysis, weather, traffic conditions, road conditions, and any other type of data that represents the driving habits of the driver, the operating condition and parameters of the vehicle, and the environment in which the vehicle is operating. The data may be collected in real time and stored until it is uploaded from the vehicle 12 through the wireless network 16 to the network 18 for downloading at workstations 20, 22. The data may be uploaded intermittently, either upon start-up of the engine, shut down of the engine, at specific time intervals, at specific mileage intervals, at service shops, or on demand or internally or externally generated request. The data may be aggregated and assimilated with other data, either prior to uploading (i.e., with other driver data from that vehicle) or after uploading (i.e., with driver data from other vehicles). The data may be aggregated at a server in an on-board computer (internal or external to the telematics device 302), a server in the network, or a remote server at a customer or partner location such as an insurance provider.

For example, the ecosystem may authenticate a driver through bio-metrics, login credentials, a key fob or chip, or any other authentication method. The ecosystem may employ parental controls and user profiles for each driver, including user profiles of parents, children, valet parkers, and even thieves. The ecosystem may provide feedback to the driver in real-time, quasi-real time, or non-real time reports. The feedback may be in the form of a visual display, including a traditional display or a heads up display, a mobile phone message, or an audio alert.

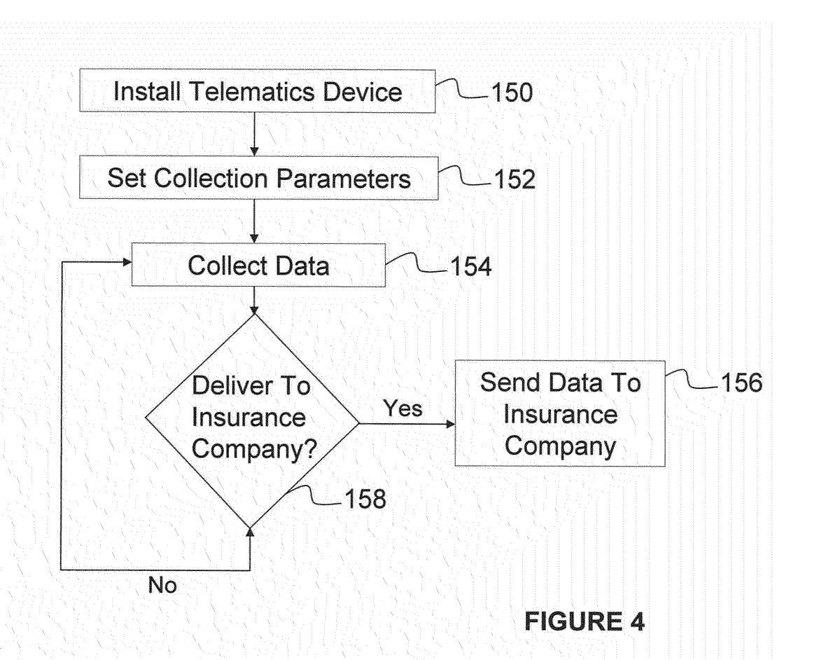

With reference to FIG. 4, there is shown a flow chart describing one embodiment of the method of the present invention. At step 150, the telematics device is installed in the vehicle. The installation may be performed at the time of manufacture, may be installed after-market by a user through the OBD-II port, or it may be tethered to other mobile telecommunications equipment. At step 152, the data collection parmeters are set, including the parameters for uploading the data. At step 154, the data is collected. At step 158, the decision is made as to whether to upload the data to the insurance company. If yes, the data is uploaded and sent to the insurance company using the wireless network 16 and the network 18. If the data is not to be uploaded at step 158, the process continues collecting data at step 154. Using this method, the insurance company is able to retrieve accurate data relating to the driver's driving experience, driving environment and vehicle conditions and would be in a position to change its rates on a variable premium policy, or revise rates next renewal period. Moreover, if the insurance company was to develop objective criteria, reports to the drivers may be used for the driver to modify driving behavior, driving environment and/or vehicle conditions in order to reduce rates. Insurance companies may also be able to aggregate reported data in order to assess overall risk and set rates accordingly.

In alternative embodiments, an insured may obtain two or more different insurance policies, one of which is active in a given set of driving conditions or driving locations and the other being active under an alternative set of driving conditions or driving locations. For example, one policy may be active when driving with city (or state) limits and another policy active for inter-city (or interstate) travel. In another alternative embodiment, different drivers of the same vehicle may have customized and differing insurance coverages or policies based on their personal driving habits.

While the present invention has been described in connection with the various embodiments of the various figures, it is to be understood that other similar embodiments can be used or modifications and additions can be made to the described embodiment for performing the same function without deviating therefrom. For example, one skilled in the art will recognize that the definitions and scopes of mobile alerts as described in the present application may apply to any environment, whether wired or wireless, and may be applied to any number of such devices connected via a communications network and interacting across the network. Therefore, the method and system of defining mobile alerts should not be limited to any single embodiment, but rather should be construed in breadth and scope in accordance with the appended claims.

What is claimed:

1. A method for brokering variable rate insurance premiums from an insurance carrier, comprising:
collecting driving information relating to a vehicle;
generating a report based on the driving information;
providing the driving report to the insurance carrier;
receiving a revised premium based on the driving report;
transmitting the revised premium to a customer.

2. The method of claim 1 wherein the collecting step is performed by a telematics device installed on a vehicle.

3. The method of claim 1 wherein the collecting step is performed by a mobile device.

4. The method of claim 1 wherein the collecting step includes receiving driving information using a wireless network.

5. The method of claim 1 wherein the driving information includes driver identification, vehicle speed and vehicle location.

6. The method of claim 1 wherein the driving information includes audio or visual data.

7. A method for providing variable rate insurance premiums from an insurance carrier;
receiving driving information collected from within a vehicle that is transmitted wirelessly from the vehicle;
analyzing the driving information based on a set of parameters;
revising an insurance premium based on the analyzing step;
sending notice of the revised premium electronically.

8. The method of claim 8 further comprising providing a telematics device to be installed within the vehicle for collecting the driving information.

9. The method of claim 7 wherein the driving information includes driver identification, vehicle speed and vehicle location.

10. The method of claim 7 wherein the driving information includes audio or visual data.

11. The method of claim 7 wherein the driving information is collected for a defined time period prior to the receiving step.

12. The method of claim 7 wherein the driving information is collected and sent in near real time and the driving information is aggragated over a defined time period prior to the analyzing step.

13. A system for providing variable rate insurance for a vehicle comprising:
a telematics unit within a vehicle configured to collect data from sensors located within the vehicle wherein the sensors provide information relating to the vehicle;
a wireless telecommunications interface connected to the telematics unit;
a network in communication with the wireless telecommunications interface;
at least one terminal connected to the network, wherein the terminal is configured to receive the information; analyze the information, and adjust insurance premiums based on the analysis of the information.

14. A telematics device for collecting driving information from a vehicle comprising;
a driver authentication module to identify a current driver of the vehicle; an interface to a GPS system for receiving location information;
a vehicle interface for collecting vehicle status data relating to one of the vehicle's driving parameters or maintenance parameters;
an interface to a wireless network configured to transmit the identify of the driver, the vehicle's location and the vehicle status data and receive data from an external source, the received data based on one of the identity of the current driver, the vehicle's location, and the vehicle status data.

15. The telematics device of claim 14 further comprising a feedback module configured to provide driving feedback to a driver.

16. The telematics device of claim 14 wherein the received data includes a rate quote from an insurer.

17. The telematics device of claim 14 wherein the received data includes a variable rate quote from an insurer.

18. The telematics device of claim 14 wherein the telematics device communicates using a browser interface.

19. The telematics device of claim 18 wherein programs and data are stored remotely from the telematics device.
